(19) United States
(12) Patent Application Publication
(10) Pub. No.: US 2023/0010874 A1
(43) Pub. Date: Jan. 12, 2023

(54) Optical Phase Modulator

(71) Applicant: Nippon Telegraph and Telephone Corporation, Tokyo (JP)

(72) Inventors: Tatsuro Hiraki, Tokyo (JP); Hiroshi Fukuda, Tokyo (JP)

(21) Appl. No.: 17/779,081

(22) PCT Filed: Nov. 28, 2019
(86) PCT No.: PCT/JP2019/046618

§ 371 Date: May 23, 2022

(51) Int. Cl. G02F 1/01; G02F 1/225; G02B 6/02

(52) U.S. Cl. CPC G02F 1/0147; G02F 1/2257; G02F 1/011; G02B 6/02; G02F 2201/12; G02F 2202/10

(57) ABSTRACT

An optical phase modulator includes a lower cladding layer, a core formed on the lower cladding layer, an upper cladding layer formed over the core, and a heater. In addition, the optical phase modulator includes a semiconductor layer which is embedded in the upper cladding layer, is disposed above the core, and is formed of a compound semiconductor, and the heater is constituted by an impurity introduction region formed in the semiconductor layer.

This patent application is a national phase filing under section 371 of PCT application no. PCT/JP2109/046618, filed on Nov. 28, 2019, which application is hereby incorporated herein by reference in its entirety.

### TECHNICAL FIELD

The present invention relates to an optical phase modulator using a thermo-optical effect.

### BACKGROUND

A technique for producing an optical phase modulator on a silicon (Si) substrate has attracted attention toward cost reduction of an optical integrated circuit. In the case of an optical circuit using an optical waveguide (Si optical waveguide) by a core (Si core) made of Si, the phase of light is modulated mainly by either a thermo-optical effect or a carrier plasma effect. An optical phase modulator using a thermo-optical effect is suitable for applications in which a reduction in optical loss is required because an increase in optical loss due to phase modulation is not involved and is used for phase adjustment of resonators of a Mach-Zehnder interferometer and a wavelength-tunable light source.

When the thermo-optical effect is used, it is necessary to dispose a heater formed by a metal wiring serving as a heat source at a position away from the Si core so as not to serve as an absorber for light that propagates (guides) the Si optical waveguide. For example, as illustrated in FIG. 14, the Si optical waveguide has a Si core 403 embedded in a cladding region 402 made of SiO₂ formed on a Si substrate 401. The thickness of the cladding region 402 between the heater 404 and the Si core 403 is set to 1 μm or more at a portion where modulation is performed.

As the thickness of the cladding region 402 between the heater 404 and the Si core 403 is smaller, heat by the heater 404 is efficiently transferred to the Si core 403. However, since the heater 404 made of a metal material has extremely large light absorption, it is difficult to thin the cladding region 402 between the heater 404 and the Si core 403. Therefore, it is not easy to efficiently transfer heat by the heater 404 to the Si core 403, and it is difficult to reduce power consumption required for phase modulation.

For this problem, it is important to form a heater by using a conductive material having a small light absorption loss and to bring the Si core and the heater close to each other. As the related art, a technique has been proposed in which an impurity is injected into a Si core to form a conductive diffusion layer wiring, and current is injected to use a Si optical waveguide (Si core) itself as a heater (see NPL 1). In this technique, the temperature of the Si waveguide core can be changed more efficiently than in a case where a heater formed by a metal wiring is used.

### CITATION LIST

### Non Patent Literature

NPL 1: N. C. Harris et al., “Efficient, compact and low loss thermo-optic phase shifter in silicon”, Optics Express, vol. 22, no. 9, pp. 10487-10493, 2014.

### SUMMARY

### Technical Problem

Incidentally, in the above-described technique, holes of about 7×10¹⁷/cm³ are injected into the Si core in order to form the heater, and free carrier absorption by carriers generated by this becomes a problem for reducing the loss. In addition, Si has high thermal conductivity, and the heat generated in a portion of the heater is easily diffused into a layer of Si other than the Si core, which hinders a local temperature rise in a region where light propagates. Thus, the above-described technique has difficulty in further reducing the power consumption.

Embodiments of the present invention have been made to solve the above problems, and an object of embodiments of the present invention is to further reduce power consumption of an optical phase modulator using a heater.

### Means for Solving the Problem

An optical phase modulator according to embodiments of the present invention includes: a lower cladding layer formed on a substrate; a core formed on the lower cladding layer; an upper cladding layer formed over the core; a semiconductor layer which is embedded in the upper cladding layer, is disposed on the core, and is formed of a compound semiconductor; a heater constituted by an impurity introduction region formed in the semiconductor layer; and a first electrode and a second electrode electrically connected to the heater.

### Effects of Embodiments of the Invention

As described above, according to embodiments of the present invention, since the heater constituted by the impurity introduction region formed in the semiconductor layer formed of the compound semiconductor is disposed above the core, it is possible to further reduce the power consumption of the optical phase modulator using the heater.

### BRIEF DESCRIPTION OF THE DRAWINGS

FIG. 1A is a cross-sectional view illustrating a configuration of a cross section perpendicular to a waveguide direction of an optical phase modulator according to a first embodiment of the present invention.

FIG. 1B is a plan view illustrating a partial configuration of the optical phase modulator according to the first embodiment of the present invention.

FIG. 2 is a distribution diagram illustrating a calculation result of a mode field pattern of an optical waveguide according to the first embodiment.

FIG. 3 is a distribution diagram illustrating a temperature distribution in a cross section perpendicular to the waveguide direction when power of 20 mW is input to a heater made of InP of the optical phase modulator of the first embodiment in which a length in the waveguide direction is 30 μm.

FIG. 4 is a distribution diagram illustrating a temperature distribution in a cross section perpendicular to the waveguide direction when power of 20 mW is input to a heater made of InGaAsP of the optical phase modulator of the first embodiment in which a length in the waveguide direction is 30 μm.

FIG. 5 is a cross-sectional view illustrating a configuration of a cross section perpendicular to a waveguide direction of another optical phase modulator according to the first embodiment of the present invention.

FIG. 6A is a cross-sectional view illustrating a configuration of a cross section perpendicular to a waveguide direction of an optical phase modulator according to a second embodiment of the present invention.

FIG. 6B is a plan view illustrating a partial configuration of the optical phase modulator according to the second embodiment of the present invention.

FIG. 7 is a cross-sectional view illustrating a configuration of a cross section perpendicular to a waveguide direction of another optical phase modulator according to the second embodiment of the present invention.

FIG. 8 is a plan view illustrating a partial configuration of another optical phase modulator according to an embodiment of the present invention.

FIG. 9 is a plan view illustrating a partial configuration of another optical phase modulator according to an embodiment of the present invention.

FIG. 10 is a plan view illustrating a partial configuration of another optical phase modulator according to an embodiment of the present invention.

FIG. 11 is a plan view illustrating a partial configuration of another optical phase modulator according to an embodiment of the present invention.

FIG. 12 is a plan view illustrating an application example of the optical phase modulator according to an embodiment of the present invention.

FIG. 13 is a plan view illustrating an application example of the optical phase modulator according to an embodiment of the present invention.

FIG. 14 is a cross-sectional view illustrating a configuration of the existing optical phase modulator.

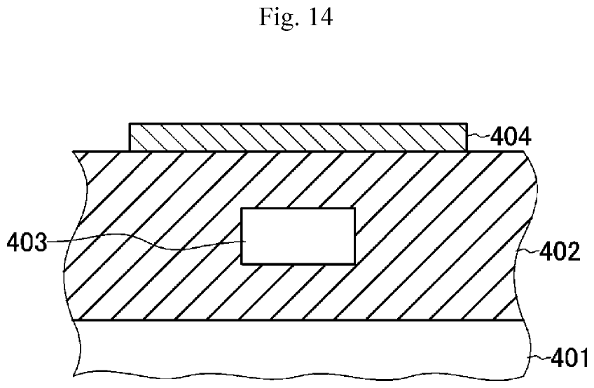

### DETAILED DESCRIPTION OF ILLUSTRATIVE EMBODIMENTS

Hereinafter, an optical phase modulator according to embodiments of the present invention will be described.

### First Embodiment

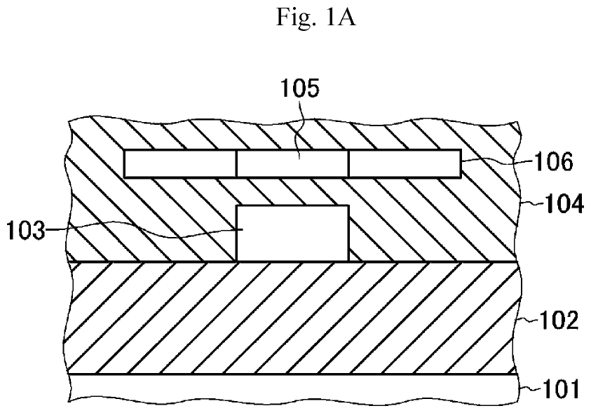

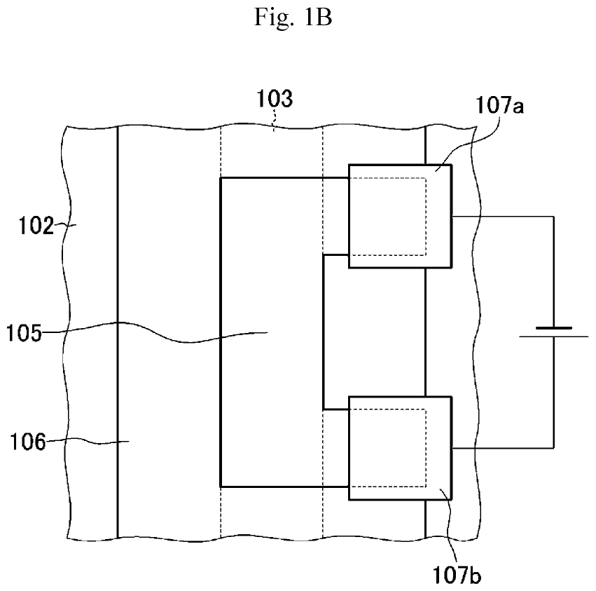

First, an optical phase modulator according to a first embodiment of the present invention will be described with reference to FIGS. 1A and 1E. The optical phase modulator includes a lower cladding layer 102 formed on a substrate 101, a core 103 formed on the lower cladding layer 102, an upper cladding layer 104 formed over the core 103, and a heater 105.

The substrate 101 is made of, for example, single crystal silicon (Si). The lower cladding layer 102 and the upper cladding layer 104 are made of, for example, SiO₂. The core 103 is made of, for example, Si. For example, a well-known silicon on insulator (SOI) substrate can be used, the base portion can be used as the substrate 101, and the buried insulating layer can be used as the lower cladding layer 102. In addition, the core 103 can be formed by patterning a surface silicon layer of the SOI substrate by known photolithography and etching techniques.

In the first embodiment, the optical phase modulator includes a semiconductor layer 106 which is embedded in the upper cladding layer 104, is disposed above the core 103, and is formed of a compound semiconductor, and the heater 105 is constituted by an impurity introduction region formed in the semiconductor layer 106. In this example, the heater 105 is disposed directly above the core 103. In other words, in the cross-sectional view perpendicular to a waveguide direction, the center of the heater 105 is disposed on a normal line of a plane of the substrate 101 passing through the center of the core 103. The semiconductor layer 106 can be formed of, for example, a group III-V compound semiconductor such as InP. In addition, for example, the heater 105 can be formed by an impurity introduction region in which Si is introduced by about 1×10¹⁸ cm⁻³.

For example, on the lower cladding layer 102 and the core 103 formed by using an SOI substrate, SiO₂ is deposited to a predetermined thickness by a well-known chemical vapor deposition (CVD) method to form an SiO₂ layer. This SiO₂ layer is to be a part of the upper cladding layer 104. Then, InP is deposited on the SiO₂ layer by a well-known metal organic chemical vapor deposition (MOCVD) method to form the semiconductor layer 106. Next, a mask pattern having an opening is formed in a region to be the heater 105, and an impurity is selectively introduced through the opening to form the heater 105. Thereafter, SiO₂ is deposited to a predetermined thickness by a CVD method to embed the semiconductor layer 106, and the upper cladding layer 104 is formed together with the SiO₂ layer that has already been formed.

A first electrode 107a and a second electrode 107b are electrically connected to the heater 105. For example, the first electrode 107a and the second electrode 107b are formed on the upper cladding layer 104 and electrically connected to the heater 105 through wirings (not illustrated) that pass through the upper cladding layer 104 on the heater 105 (semiconductor layer 106). In the first embodiment, the connection portion between the first electrode 107a and the heater 105 and the connection portion between the second electrode 107b and the heater 105 are disposed at a predetermined interval in a waveguide direction of an optical waveguide with the core 103. By connecting the first electrode 107a and the second electrode 107b to a power source, current can be passed through the heater 105. As a result of the current flowing in this manner, the heater 105 generates heat. On the other hand, the semiconductor layer 106 excluding the heater 105 has no impurity introduced and is of the i type and has high resistance, and current does not flow therethrough. The waveguide direction is a vertical direction in the drawing sheet of FIG. 1B and is a front to back direction in the drawing sheet of FIG. 1A.

Connecting the power source to the first electrode 107a and the second electrode 107b to pass current through the heater 105 causes a rise in temperature of the core 103 directly below the substrate side of the heater 105. As a result, a phase shift due to a thermo-optical effect occurs in light that guides the optical waveguide with the core 103 at this portion.

For example, InP is larger in energy of a bandgap than energy of near infrared light that propagates (guides) the optical waveguide (Si optical waveguide) with the core 103 made of Si. Thus, InP is a material that is transparent to the near infrared light that guides the Si optical waveguide. InP is also a material having extremely high electron mobility (approximately 10 times that of Si), and the heater 105, which is configured by an impurity introduction region in which an n-type impurity is introduced into InP and has a high carrier concentration, has extremely small free carrier absorption in this region.

As described above, according to the first embodiment, even when the heater 105 is disposed at a close distance that allows the heater 105 to be optically connected to the core 103, the light loss is extremely small as compared to the related art. In addition, since the InP-based material has thermal conductivity smaller than that of Si, the diffusion of heat generated in the heater 105 is small, and the local temperature rise is large. As a result, according to the first embodiment, phase modulation with high efficiency is possible. This also applies when the heater 105 is made of InGaAsP.

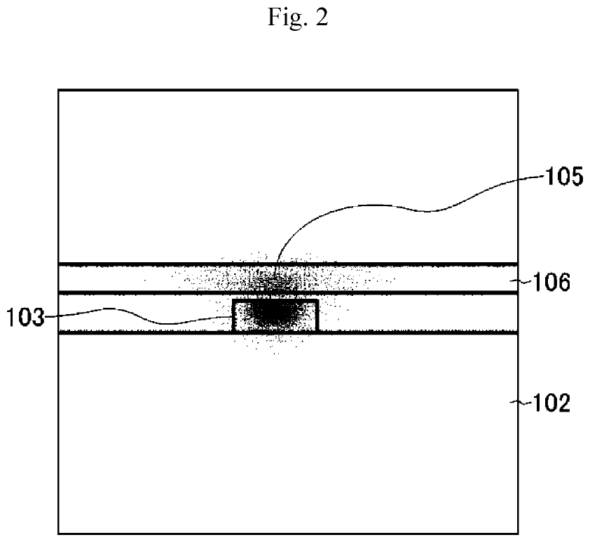

FIG. 2 illustrates a calculation result of a mode field pattern of the optical waveguide according to the first embodiment described above. In this calculation, the size of the cross section of the core 103 is 220×440 nm², the thickness of the heater 105 (semiconductor layer 106) is 200 nm, and the interval between the core 103 and the heater 105 in the thickness direction is 200 nm. The core 103 is made of Si, the heater 105 is made of n-type InP, and the upper cladding layer 104 is made of SiO₂.

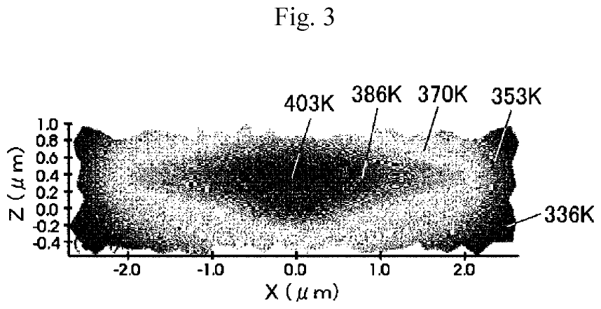

As illustrated in FIG. 2, an optical beam is also coupled to the heater 105, but the n-type InP constituting the heater 105 has an extremely small free carrier absorption coefficient, and thus has a low loss. Since the thermo-optical coefficient of InP is equal to that of Si, a component of the light coupled to the heater 105 also contributes to phase modulation. FIG. 3 illustrates a temperature distribution in a cross section perpendicular to the waveguide direction when power of 20 mW is input to the optical phase modulator (phase shifter) of the first embodiment in which the length in the waveguide direction is 30 μm.

In FIG. 3, the temperature of the core 103 disposed in the vicinity of the X-coordinate 0.0 and the Z-coordinate 0.1 rises by nearly 90° C. with respect to the room temperature (298 K). The Z-axis direction is the thickness direction. When the interval between the core 103 and the heater 105 is about 50 nm, the difference in temperature rise between the core 103 and the heater 105 is very small. InP constituting the heater 105 (semiconductor layer 106) has thermal conductivity lower than that of Si constituting the core 103. Therefore, the heat generated in the heater 105 is less likely to diffuse to the entire semiconductor layer 106, which also contributes to improving a local temperature rise in the vicinity of the core 103. As a result, this further contributes to improvement in efficiency of the phase shift.

Here, the impurity introduced to function as the heater 105 is desirably an element that forms a donor in InP. The n-type InP has smaller free carrier absorption than p-type InP. In addition, the thickness of the semiconductor layer 106 (heater 105) may be sufficient to obtain a desired resistivity, but it is desirable that the thickness is as thin as possible because the optical confinement factor to the core 103 with a lower loss is improved. Similarly, the concentration of the impurity described above may be sufficient to obtain a desired resistivity, but a low concentration is desirable because free carrier absorption can be suppressed. The distance between the heater 105 and the core 103 is desirably as small as possible.

Incidentally, the thermal conductivity of the InP-based material can be adjusted by composition, and for example, the semiconductor layer 106 (heater 105) can also be made of InGaAsP having a band gap wavelength of 1.3 μm, for example. This InGaAsP has thermal conductivity lower than that of InP and has extremely small thermal diffusion to a region other than the region of the heater 105. Therefore, it is possible to improve a local temperature rise rate in the vicinity of the core 103 made of Si.

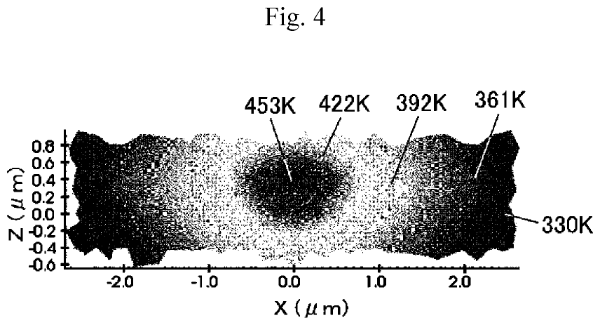

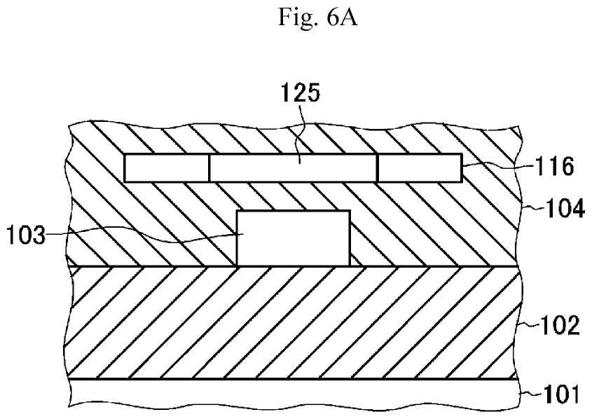

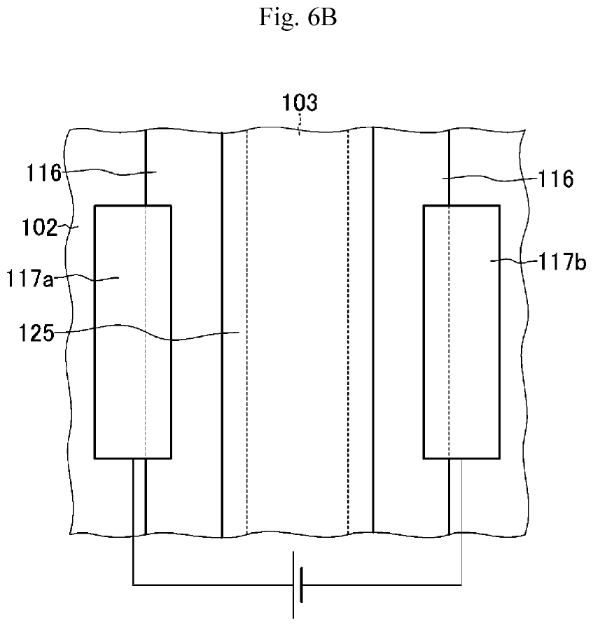

FIG. 4 illustrates a temperature distribution in a cross section perpendicular to the waveguide direction when power of 20 mW is input to the optical phase modulator (phase shifter) of the first embodiment using the heater 105 made of InGaAsP in which the length in the waveguide direction is 30 μm. Also in FIG. 6, the core 103 is disposed in the vicinity of the X-coordinate 0.0 and the Z-coordinate 0.1. As compared to the case where the heater 105 is made of InP (FIG. 4), the heat generated in the heater region is distributed in the vicinity of the core in a concentrated manner, and it can be seen that the temperature rise value is larger than that in the case where the heater is made of InP.

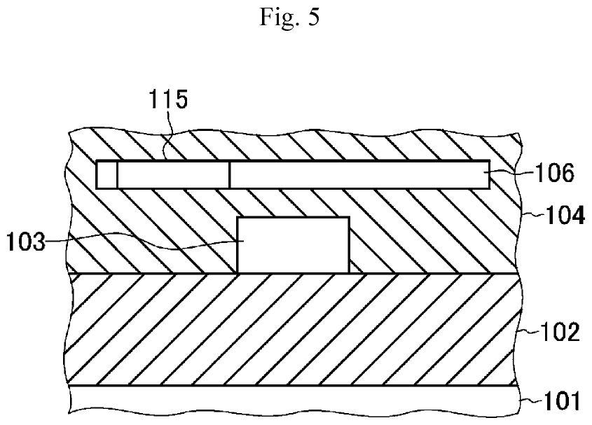

In the above description, the heater 105 is disposed directly above the core 103, but the present invention is not limited thereto. For example, as illustrated in FIG. 5, the heater 115 can also be formed in the semiconductor layer 106 in a portion other than directly above the core 103. As described above, in the cross-sectional view perpendicular to the waveguide direction, the center of the heater 115 can also be disposed at a position shifted from the normal line of the plane of the substrate 101 passing through the center of the core 103. In the example illustrated in FIG. 5, the heater 115 is disposed in a region other than the formation region of the core 103 in plan view.

### Second Embodiment

Next, an optical phase modulator according to a second embodiment of the present invention will be described with reference to FIGS. 6A and 6B. The optical phase modulator includes a lower cladding layer 102 formed on a substrate 101, a core 103 formed on the lower cladding layer 102, an upper cladding layer 104 formed to cover the core 103, and a heater 125.

The substrate 101, the lower cladding layer 102, the core 103, and the upper cladding layer 104 are the same as those of the first embodiment described above.

In the second embodiment, the optical phase modulator includes a semiconductor layer 116 which is embedded in the upper cladding layer 104, is disposed above the core 103, and is formed of a compound semiconductor, and the heater 125 is constituted by an impurity introduction region formed in the semiconductor layer 116. In this example, the heater 125 is disposed directly above the core 103. Further, the semiconductor layer 116 can be formed of, for example, a group III-V compound semiconductor such as InP or InGaAsP. In addition, for example, the heater 125 can be formed by an impurity introduction region in which Si is introduced by about 1×10¹⁸ cm⁻¹.

A first electrode 117a and a second electrode 117b are electrically connected to the heater 125. In the second embodiment, the connection portion between the first electrode 117a and the heater 125 and the connection portion between the second electrode 117b and the heater 125 are disposed at a predetermined interval with the core 103 interposed therebetween so as to intersect the waveguide direction of the optical waveguide with the core 103.

By connecting the first electrode 117a and the second electrode 117b to a power source, current can be passed through the heater 125. As a result of the current flowing in this manner, the heater 125 generates heat. On the other hand, the semiconductor layer 116 excluding the heater 125 is not introduced with an impurity and is of the i type and has high resistance, and current does not flow therethrough. The waveguide direction is a vertical direction in the drawing sheet of FIG. 6B and is a front to back direction in the drawing sheet of FIG. 6A.

By connecting the power source to the first electrode 117a and the second electrode 117b to pass current through the heater 125, the temperature of the core 103 directly below the substrate side of the heater 125 increases. As a result, a phase shift due to a thermo-optical effect occurs in light that guides the optical waveguide with the core 103 at this portion.

Similar to the first embodiment described above, InP is larger in energy of a bandgap than energy of near infrared light that propagates (guides) the optical waveguide (Si optical waveguide) with the core 103 made of Si. Thus, InP is a material that is transparent to the near infrared light that guides the Si optical waveguide. InP is a material having extremely high electron mobility (approximately 10 times Si), and the heater 125, which is configured by an impurity introduction region in which an n-type impurity is introduced into InP and has a high carrier concentration, is extremely small in free carrier absorption in this region.

As described above, also in the second embodiment, even if the heater 125 is disposed at a close distance that allows the heater 125 to be optically connected to the core 103, the light loss is extremely small as compared to the related art. In addition, since the InP-based material has thermal conductivity smaller than that of Si, the diffusion of heat generated in the heater 125 is small, and the local temperature rise is large. As a result, also in the second embodiment, phase modulation with high efficiency is possible. This is the same even if the heater 125 is made of InGaAsP.

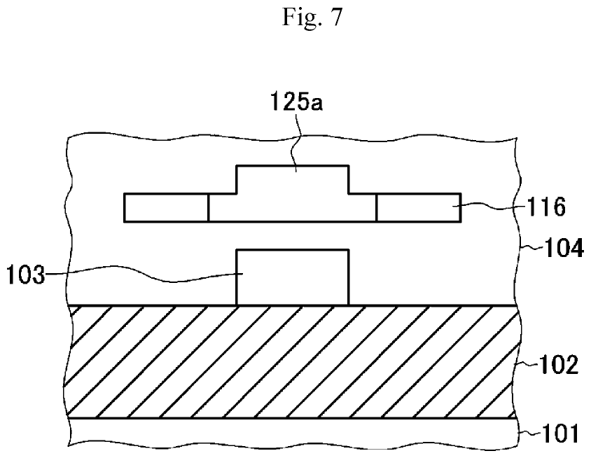

As illustrated in FIG. 7, a heater 125a can also have a shape having a protrusion on its upper surface in the cross-sectional view perpendicular to the waveguide direction. This is similar to the structure of a core in a rib-type optical waveguide. With this configuration, optical confinement in the heater 125a can be improved.

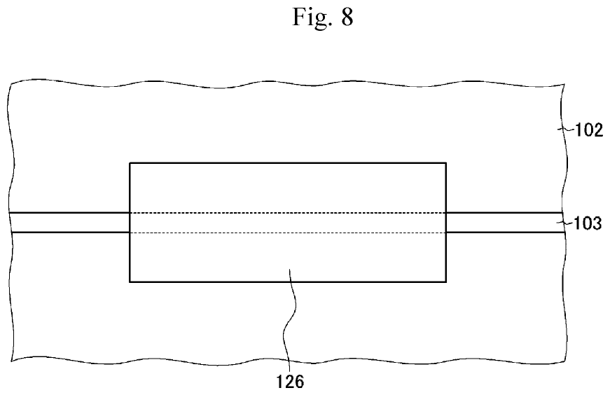

When the semiconductor layer forming the heater is sufficiently thin, the semiconductor layer can also be formed in a partial region in the waveguide direction. For example, as illustrated in FIG. 8, a semiconductor layer 126 having a rectangular shape in plan view can also be disposed in a partial region in the waveguide direction of the optical waveguide with the core 103. For example, an n-type impurity is introduced into a region corresponding to a portion above the core 103 in the central portion of the semiconductor layer 126 in plan view to form a heater. In this case, the light that guides the optical waveguide with the core 103 is optically coupled to the semiconductor layer 126 in the formation region of the semiconductor layer 126. When the semiconductor layer 126 is sufficiently thin, the mode shape between the core 103 and the semiconductor layer 126 is very close, so that low-loss coupling can be performed.

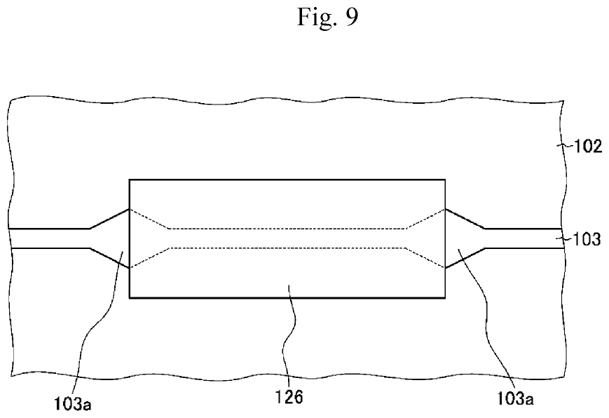

In addition, as illustrated in FIG. 9, the core 103 can also include mode conversion portions 103a each having a wider width, with respect to an end of the semiconductor layer 126 in the waveguide direction, at a position closer to the end in plan view. By forming the mode conversion portions 103a in this manner, it is also possible to extremely reduce the optical coupling to the semiconductor layer 126, reduce the mode mismatch, and perform coupling with low loss. In this case, in order to prevent the optical waveguide with the core 103 in the region where the optical phase modulation is performed from becoming a multimode waveguide, in the heater region, the width of the core 103 is narrowed in plan view.

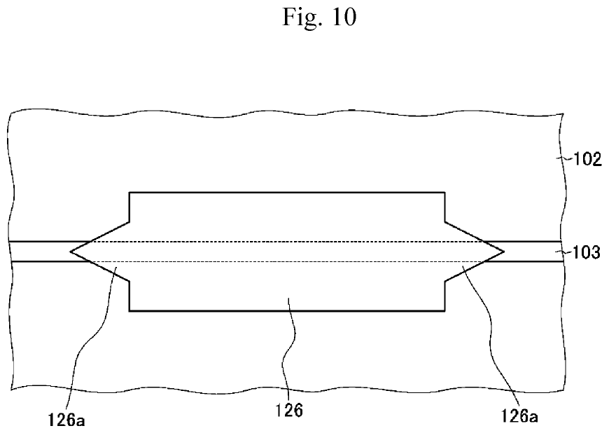

In addition, as illustrated in FIG. 10, the semiconductor layer 126 can also include convex portions 126a each having a narrower width, with respect to an end of the semiconductor layer in the waveguide direction, at a larger distance from the end in plan view in an upper region of the core. By forming the convex portions 126a in this manner, it is also possible to extremely reduce the optical coupling to the semiconductor layer 126, reduce the mode mismatch, and perform coupling with low loss.

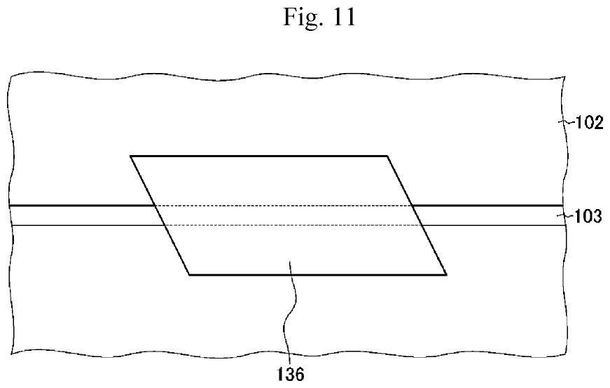

In addition, as illustrated in FIG. 11, in plan view, the side of the semiconductor layer 136 which intersects the core 103 can also be inclined from the side perpendicular to the waveguide direction. In this way, it is possible to reduce entry of reflected light into the core 103 as stray light at a portion where the core 103 and the formation region of the semiconductor layer 136 overlap in plan view.

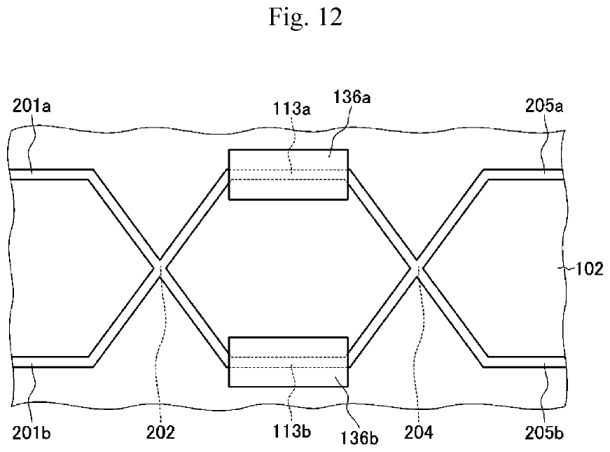

Next, application of the optical phase modulator of embodiments of the present invention will be described. By using this optical phase modulator, a Mach-Zehnder interferometer can be configured. For example, as illustrated in FIG. 12, a semiconductor layer 136a and a semiconductor layer 136b are provided in a first arm 113a and a second arm 113b constituting the Mach-Zehnder interferometer, respectively. In each of the semiconductor layer 136a and the semiconductor layer 136b, an n-type impurity is introduced into each of regions corresponding to the portions above the first arm 113a and the second arm 113b in the central portion to form a heater.

The Mach-Zehnder interferometer includes a first core 201a, a second core 201b, a first multiplexing/demultiplexing portion 202, the first arm 113a, the second arm 113b, a second multiplexing/demultiplexing portion 204, a third core 205a, and a fourth core 205b. The signal light input to the optical waveguide by the first core 201a or the optical waveguide by the second core 201b is demultiplexed into the optical waveguide by the first arm 113a and the optical waveguide by the second arm 113b by the first multiplexing/demultiplexing portion 202.

The signal light which is demultiplexed by the first multiplexing/demultiplexing portion 202 and guides the optical waveguide by the first arm 113a and the optical waveguide by the second arm 113b is multiplexed by the second multiplexing/demultiplexing portion 204, guides the optical waveguide by the third core 205a or the optical waveguide by the fourth core 205b, and is output. By individually controlling the temperature of the heater in the first arm 113a and the temperature of the heater in the second arm 113b, an interferometer can be obtained.

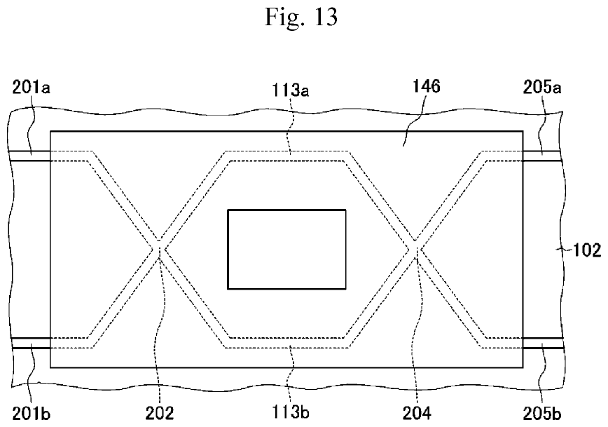

In addition, when the semiconductor layer and the core of the optical waveguide are optically coupled by, for example, a taper, a phase error due to a taper shape error occurs between both arms. On the other hand, as illustrated in FIG. 13, a semiconductor layer 146 is formed beyond the regions of the first arm 113a and the second arm 113b, and the semiconductor layer 146 and the core of the optical waveguide are coupled in the region other than the first arm 113a and the second arm 113b, so that the occurrence of the phase error can be suppressed. In this example, the semiconductor layer 146 is formed such that one side facing the waveguide direction of the semiconductor layer 146 having a rectangular shape in plan view intersects the first core 201a and the second core 201b, and the other side intersects the third core 205a and the fourth core 205b.

As described above, according to embodiments of the present invention, since the heater constituted by the impurity introduction region formed in the semiconductor layer formed of the compound semiconductor is disposed above the core, it is possible to further reduce the power consumption of the optical phase modulator using the heater.

Meanwhile, the present invention is not limited to the embodiments described above, and it will be obvious to those skilled in the art that various modifications and combinations can be implemented within the technical idea of the present invention.

### REFERENCE SIGNS LIST

101 Substrate
102 Lower cladding layer
103 Core
104 Upper cladding layer
105 Heater
106 Semiconductor layer
107a First electrode
107b Second electrode

1-8. (canceled)

9. An optical phase modulator comprising:
a lower cladding layer on a substrate;
a core on the lower cladding layer;
an upper cladding layer over the core;
a semiconductor layer embedded in the upper cladding layer, disposed on the core, and comprising a compound semiconductor;
an impurity introduction region in the semiconductor layer, the impurity introduction region defining a heater; and
a first electrode and a second electrode electrically connected to the heater.

10. The optical phase modulator according to claim 9, wherein a first connection portion between the first electrode and the heater and a second connection portion between the second electrode and the heater are disposed at a predetermined interval in a waveguide direction of an optical waveguide with the core.

11. The optical phase modulator according to claim 9, wherein a first connection portion between the first electrode and the heater and a second connection portion between the second electrode and the heater are disposed at a predetermined interval with the core interposed therebetween to intersect in a waveguide direction of an optical waveguide with the core.

12. The optical phase modulator according to claim 9, wherein the semiconductor layer is disposed in a partial region in a waveguide direction of an optical waveguide with the core.

13. The optical phase modulator according to claim 12, wherein the core comprises a mode conversion portion having a wider width, with respect to an end of the semiconductor layer in the waveguide direction, at a position closer to the end in plan view than at a position farther from the end in the plan view.

14. The optical phase modulator according to claim 12, wherein the semiconductor layer comprises a convex portion having a narrower width, with respect to an end of the semiconductor layer in the waveguide direction, at a position farther from the end in plan view than at a position closer to the end in the plan view in an upper region of the core.

15. The optical phase modulator according to claim 12, wherein a side of the semiconductor layer which intersects the core is inclined from a side perpendicular to the waveguide direction in plan view.

16. The optical phase modulator according to claim 9, wherein the semiconductor layer comprises InP or InGaAsP.

17. A method of forming an optical phase modulator, the method comprising:
forming a lower cladding layer on a substrate;
forming a core on the lower cladding layer;
forming an upper cladding layer over the core;
forming a semiconductor layer embedded in the upper cladding layer, disposed on the core, and comprising a compound semiconductor;
forming a heater by introducing an impurity into an impurity introduction region of the semiconductor layer; and
forming a first electrode and a second electrode electrically connected to the heater.

18. The method according to claim 17, wherein a first connection portion between the first electrode and the heater and a second connection portion between the second electrode and the heater are disposed at a predetermined interval in a waveguide direction of an optical waveguide with the core.

19. The method according to claim 17, wherein a first connection portion between the first electrode and the heater and a second connection portion between the second electrode and the heater are disposed at a predetermined interval with the core interposed therebetween to intersect in a waveguide direction of an optical waveguide with the core.

20. The method according to claim 17, wherein the semiconductor layer is disposed in a partial region in a waveguide direction of an optical waveguide with the core.

21. The method according to claim 20, wherein the core comprises a mode conversion portion having a wider width, with respect to an end of the semiconductor layer in the waveguide direction, at a position closer to the end in plan view than at a position farther from the end in the plan view.

22. The method according to claim 20, wherein the semiconductor layer comprises a convex portion having a narrower width, with respect to an end of the semiconductor layer in the waveguide direction, at a position farther from the end in plan view than at a position closer to the end in the plan view in an upper region of the core.

23. The method according to claim 20, wherein a side of the semiconductor layer which intersects the core is inclined from a side perpendicular to the waveguide direction in plan view.

24. The method according to claim 17, wherein the semiconductor layer comprises InP or InGaAsP.
